(19) United States
(12) Patent Application Publication
(10) Pub. No.: US 2009/0315735 A1
(43) Pub. Date: Dec. 24, 2009

(54) Patient flow management and analysis using location tracking

(76) Inventors: Neeraj S. Bhavani, Ladera Ranch, CA (US); Girish Kulkarni, Oak Park, CA (US)

Correspondence Address: Richard C. Kim;Morrison & Foerster LLP, Suite 100, 12531 High Bluff Drive, San Diego, CA, 92130-2040, US

(21) Appl. No.: 12/384,428

(22) Filed: Apr. 2, 2009

Related U.S. Application Data
(63) Continuation-in-part of application No. 12/259,427, filed on Oct. 28, 2008.
Application No. 12/259,427 is a continuation-in-part of application No. 11/733,056, filed on Apr. 9, 2007.
(60) Provisional application No. 60/791,058, filed on Apr. 10, 2006.
(60) Provisional application No. 60/822,737, filed on Aug. 17, 2006.
(60) Provisional application No. 60/984,809, filed on Nov. 2, 2007.
(60) Provisional application No. 61/041,726, filed on Apr. 2, 2008.
(60) Provisional application No. 61/075,996, filed on Jun. 26, 2008.

(51) Int. Cl. G08B 5/22

(52) U.S. Cl. 340/825.49

(57) ABSTRACT

A patient flow system and method manages patients in a medical facility by tagging patients, medical staff, and medical assets with wireless locator tags, and assigning a patient flow pattern to each patient. As the patient moves throughout the medical facility, the patient tag sends location information to a management computer to track the patient's progress through the patient flow pattern. The patient's next state is determined by analyzing the patient's location as well as the patient's current and previous states.

This application is a continuation-in-part of non-provisional application Ser. No. 12/259427 filed Oct. 28, 2008, which is a continuation-in-part of non-provisional application Ser. No. 11/733056 filed Apr. 9, 2007, which claims to provisional application No. 60/791058 filed Apr. 10, 2006 and to provisional application No. 60/822737 filed Aug. 17, 2006. Ser. No. 12/259427 claims priority to provisional application 60/984809 filed Nov. 2, 2007. This application also claims priority to provisional application No. 61/041726, filed Apr. 2, 2008. All prior applications are incorporated by reference in their entirety.

### FIELD OF THE INVENTION

The field of the invention is medical care management systems.

### BACKGROUND

Tracking patients within a medical facility is a difficult and time-intensive process. Patients frequently need to be seen by multiple medical staff members and need to be treated with multiple hospital resources. Efficiently moving patients through the various rooms can be prone to human error and can be incredibly difficult, especially as patients hit bottlenecks throughout the day. U.S. Pat. No. 7,480,629 to Dashefsky teaches modeling patient flow through a hospital using statistics collected from the hospital staff on an hourly basis. However, Dashefsky requires the data to be collected by interviewing hospital staff and extracting information from hospital records and databases, which can be incredibly time-consuming for an already overworked medical staff. In addition, Dashefsky can only run reports after all the data has been inputted into the system, which typically occurs at the end of the day.

Dashefsky and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

US2006/0282302 to Hussain manages patient flow in a medical facility by integrating the patient flow analysis system with the medical facility's process, so that as patients are being treated, the medical staff updates the system dynamically. While Hussain allows the system to Hussain still requires manual input from the hospital staff, which increases the patient's waiting time.

Thus, there is still a need for a patient flow optimizer that automatically updates the patient flow system with information as patients are being treated.

### SUMMARY OF THE INVENTION

The inventive subject matter provides apparatus, systems and methods in which a patient's progress through a patient flow pattern is automatically tracked using locator tags associated with objects in the patient flow pattern. For example, a patient tag could be associated with a patient, an asset tag could be associated with an asset, and a staff tag could be associated with medical staff. Preferably, tags are associated with objects by physically clipping them to the object, for example by use of a wrist band or a lanyard.

Each tag is preferably a wireless transmitter that is attached to the patient in some way, and is in constant communication with wireless detectors that track the location of the tag. In this way, the tag automatically sends the tag location to any computer system functionally connected with the wireless detectors. As used herein, a “wireless detector” could be any device that tracks the location of a tag wirelessly, for example a GPS satellite, an RFID (radio frequency identification) locator, an ultrasound detector, a wi-fi router, or an ultra-wide band device. Preferably the wireless detectors are dispersed throughout a medical facility, for example a hospital, to automatically detect and pinpoint the location of tags throughout the medical facility. It is contemplated that the wireless detectors could be distributed among a plurality of medical facilities or in parks, homes, and other useful locations.

The detectors are functionally connected to a management computer that is configured to track a patient's progress through a patient flow pattern. Typically, a patient flow engine is installed on one or more management computers to create, control, and modify patient control patterns. As used herein, a “computer” is one or more machines that act together to perform calculations. As used herein, “functionally connected” means that the detectors could send information, data or other signals to and from the management computer, for example over an Ethernet cable, a Wi-Fi network, IP over power line, or a Bluetooth connection. The management computer is preferably accessible through a plurality of user interface terminals so that users of the system could compose, view, update, and modify the patient flow pattern dynamically.

In addition to tracking the tag locations of the patients, assets, and staff, the management computer also assigns a patient flow pattern to a patient. Patient flow patterns consist of various states of a patient's medical treatment. For example, a patient flow pattern could consist of a registration state, a waiting room state, a nurse preliminary examination state, a doctor examination state, a prescription retrieval state, a payment state, and a check-out state. Each state could be associated with one or more locations so that the management computer automatically assigns the patient from a first state to a second state as a function of the location of the patient tag coinciding with a trigger location. A command could be sent to a staff member to bring the patient to a second state location after assigning the patient to the second state.

For example, if the patient tag coincides with a prescription desk location, the management computer could assign the patient from the doctor examination state to a prescription retrieval state, and could instruct a nurse to bring the patient to the prescription retrieval desk. Or if the patient tag coincides with the waiting room for thirty minutes, the management computer could automatically assign the patient to the waiting room state from the registration state. Patient states could also be changed through a user interface on a computer, or through a trigger signal sent from a medical staff tag. As used herein, a first location “coinciding with” a second location means that the first location overlaps the second location. Locations could be defined in any suitable manner, but are preferably defined by a rectangular perimeter of a room or group of rooms, or by a circular radius from a tag location.

Preferably the patient flow pattern is assigned to a patient automatically. For example, as a patient walks into a walk-in clinic or an emergency room, the patient could be handed a tag and could be directed to enter the first state of the patient flow pattern. Preferably, a user interface is provided that allows a user to enter information about the patient so that the information is received by a computer in the system. A customized patient flow pattern could then be automatically proposed to a user of the system based upon the information about the patient, and the user could then assign that custom flow pattern to the patient. Alternatively, the user interface could allow the user to select the patient flow pattern from a plurality of optional flow patterns based upon information about the patient. In an exemplary embodiment, the system itself could automatically assign the patient flow pattern to a patient after the patient enters his or her information into the user interface.

As the patient receives medical treatment, users of the system could modify the patient flow pattern, or the patient flow pattern could be modified automatically. For example, after a doctor sees a patient, he may decide that the patient needs a blood transfusion immediately, and will insert a series of states necessary for a blood transfusion into the patient flow. Alternatively, if a nurse escorts the patient to a blood transfusion station, the patient flow engine could automatically detect that the patient tag coincides with the blood transfusion station and insert additional states accordingly.

Assets in the hospital could also be tagged and tracked for use in the patient flow pattern. In one embodiment, the patient flow engine sends a command to a staff member to bring an asset to a target asset location. For example, a staff member could be instructed to bring empty gurneys into a gurney waiting area during an operation. Or a nurse could be instructed to bring medication to a patient's bed. In an exemplary embodiment, when the patient flow pattern controls a patient's operation, the patient flow engine could instruct nurses to first prep the operating room, and once all the nurses and the necessary hospital assets are brought into the operating room, the surgeon could be paged to start the operation.

Multiple patient flows could be proposed, assigned, tracked, and modified for different procedures in a medical facility or group of medical facilities. Preferably, a display screen, dashboard, or some other visual representation on a user interface could visually provide the state of patients in their patient flow in real time. For example, a screen could display a patient identifier next to a patient location in the way airport screens display flight numbers with gate numbers. This helps optimize the throughput of patients in real time by allocating patients towards states with available resources or vice versa, and could also assist interested parties, for example family members, in tracking a patient's progress. Preferably, the dashboard is automatically populated with information about patients and procedures.

A database or group of databases preferably holds information regarding the patients and the assets so that reports could be created at a later date. A reporting engine could preferably provide various reports after data has been collected, for example reports on patient movement through various locations or states in the patient flow pattern, on the length of time patients spend in each location or state, or when patients are assigned to the states, or on bottlenecks during different times of the day or different days. This reporting engine could be run automatically at specified intervals, or automatically during pre-designated time periods. Preferably, the report runs dynamically within every 5, 10, 15, or 30 minutes so that workers in the hospital are dynamically informed of bottlenecks and problems before they arise.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a patient flow management system that tracks the locations of patients, medical staff, and medical assets through patient flow patterns.

FIG. 1A is a plan view of a patient and a wireless detector that fail to coincide with one another.

FIG. 1B is a plan view of the patient and wireless detector of Figure IA coincide with one another.

FIG. 2 is a blown up view of a user interface of FIG. 1.

FIG. 3 is a blown up view of part of the user interface of FIG. 2.

FIG. 4 is a blown up view of another part of the user interface of FIG. 2.

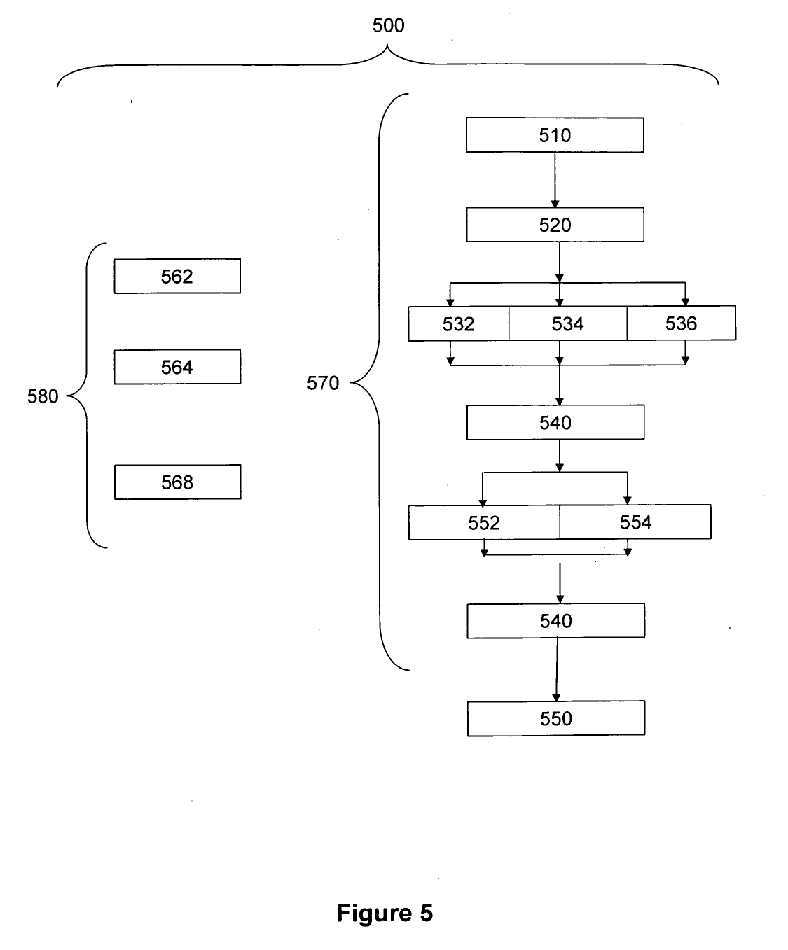

FIG. 5 is a patient flow pattern in accordance with one embodiment of the invention.

FIG. 6 is an alternate patient flow management system.

FIG. 7 is a blown up view of a user interface of FIG. 6.

### DETAILED DESCRIPTION

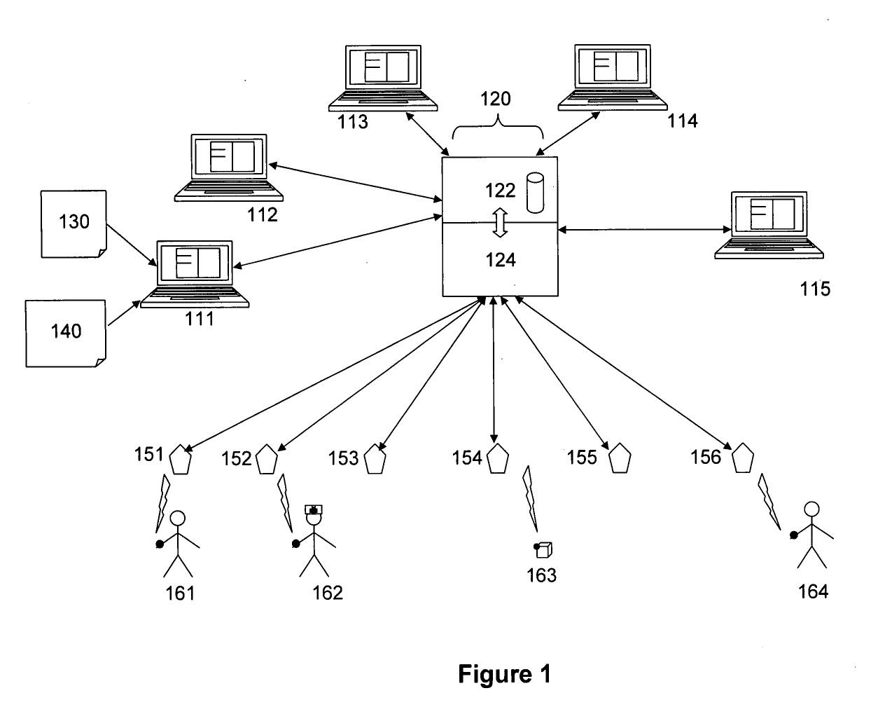

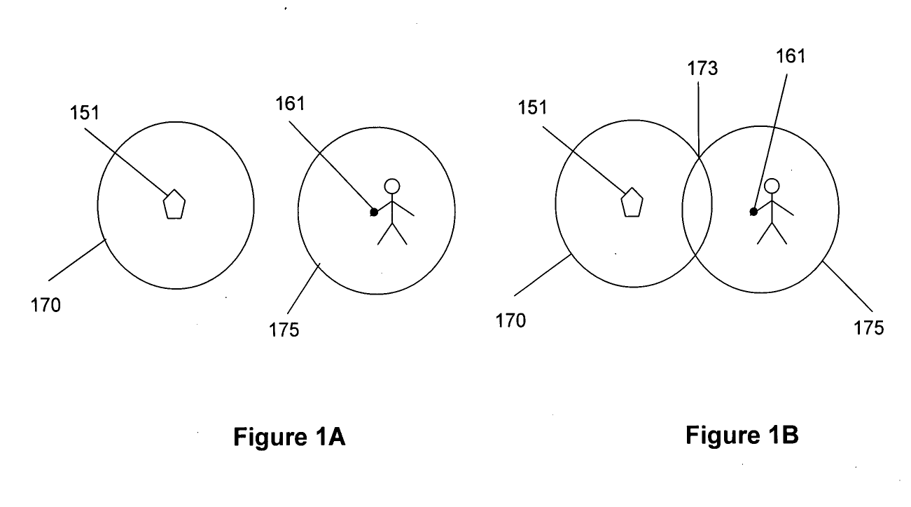

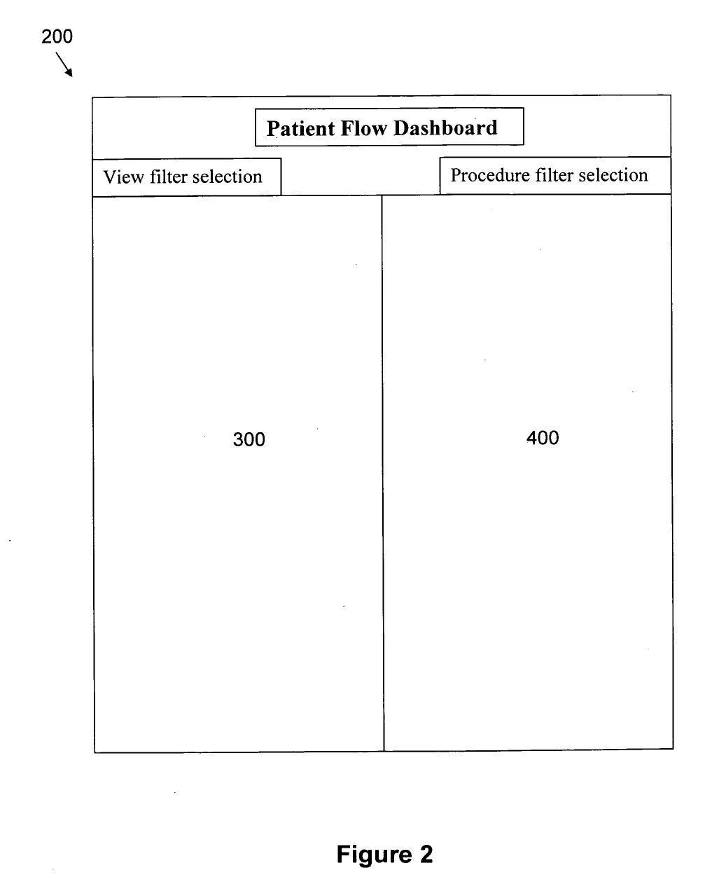

In FIG. 1, a patient flow management system generally has a management computer 120 functionally connected to user interfaces 111, 112, 113, 114, 115 and to wireless detectors 151, 152, 153, 154, 155, 156. Management computer 120 is shown as being connected to the user interfaces and the wireless detectors through bi-directional Ethernet wires, but could also be connected through a variety of means without departing from the scope of the current invention, including with wireless devices or unidirectional connection systems.

Management computer 120 has a patient flow engine 122 that tracks the patients' progress through patient flow patterns by communicating with location engine 124 that tracks tags that are detected by wireless detectors 151, 152, 153, 154, 155, 156. Each wireless detector monitors an area of the medical facility to detect patient tags entering that area. When a patient tag enters an area that is being monitored by the wireless detector, the detector can then alert the location engine about the location of the patient tag. Preferably, the location engine will track the location of the patient tag in three dimensions, to detect patients who have fallen or have transferred to different floors, and also logs the speed at which the patient tag is moving. Multiple wireless detectors can cover the same area to increase the accuracy of the location measurements. In preferred embodiments, the location information is accurate within 10 meters (32.81 feet), within 5 meters (16.4 feet), within 1 meter (3.281 feet), or even within 10 centimeters (3.937 inches). Different kinds of wireless detectors could be mixed, depending on the accuracy needed in that particular location. For example RFID detectors and Wi-Fi detectors could be used together.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

The patient flow engine monitors one or more trigger locations that are set to change the state of a patient if his or her patient tag coincides with the trigger location. To help illustrate the concept of locations coinciding with one another, FIGS. 1A and 1B show patient tag 161 with a location 175 and wireless detector 151 with trigger location 170. Trigger location 170 is set to be a 5 meter (16.4 feet) radius around wireless detector 151, and location 175 of patient tag 161 is set to be a 5 meter (16.4 feet) radius around patient tag 161. In FIG. 1A, location 175 does not coincide with trigger location 170. However, in FIG. 1B, location 175 coincides with trigger location 170 at 173. While trigger location 170 is shown as a perfect sphere, a trigger location could be designated in multiple ways. For example, the radius could be set anywhere from a few centimeters to hundreds of meters, or a trigger location could be designated to be the walls of a room, or could be a particular horizontal level in an operating room to detect when a patient has been transferred to an operating table.

Patient tags 161 and 164, medical staff tag 162, and medical asset tag 163 are all monitored by the wireless detectors 151, 152, 153, 154, 155, 156. Since the tags are typically attached to patients, medical staff, or medical assets, tracking the tag could be correlated with tracking the patients, medical staff, or medical assets, respectively. By knowing the exact location of the patient, medical staff, or medical assets within a few meters or even a few centimeters, the patient flow engine could infer the progress of patients. For example, if a patient moves from a waiting room to a preop room, the patient flow engine could reasonably infer that the patient is now undergoing preop procedures. Or if a patient has been in an MRI room for over an hour, the patient flow engine could reasonably infer that the patient is over 80% done with that state. Or if a patient location coincided with a nurse location, but now coincides with a doctor location, the patient flow engine could reasonably infer that the nurse's exam has completed and the doctor's exam has begun. This intelligent processing could eliminate the need for human input at all except the initial point of entry of the patient.

In addition to monitoring the patient's progress through a patient flow pattern, the patient flow engine could merely monitor the patient's location and report that information to one or more of the user interfaces 111, 112, 113, 114, 115. An alert could be sent to staff if a patient wanders outside of a pre-designated area, or if a patient tag changes height drastically, indicating a fall. The wireless detectors could also be configured to send data to the patient tags, giving the patient oral instructions as to where to go next, or providing information to a doctor examining the patient. The user interface could be any suitable interface for receiving or trading information, for example a terminal for a computer system, a computer functionally connected to a network, a display screen mounted in a waiting room, or even a hand-held wireless transmitter. Preferably, the user interface allows a user to input a patient flow definition 130 and/or patient information 140 into the management computer. Information concerning the location of patient tags, medical staff tags, and asset tags at various times of the day are stored in the patient flow engine database to create useful reports later on.

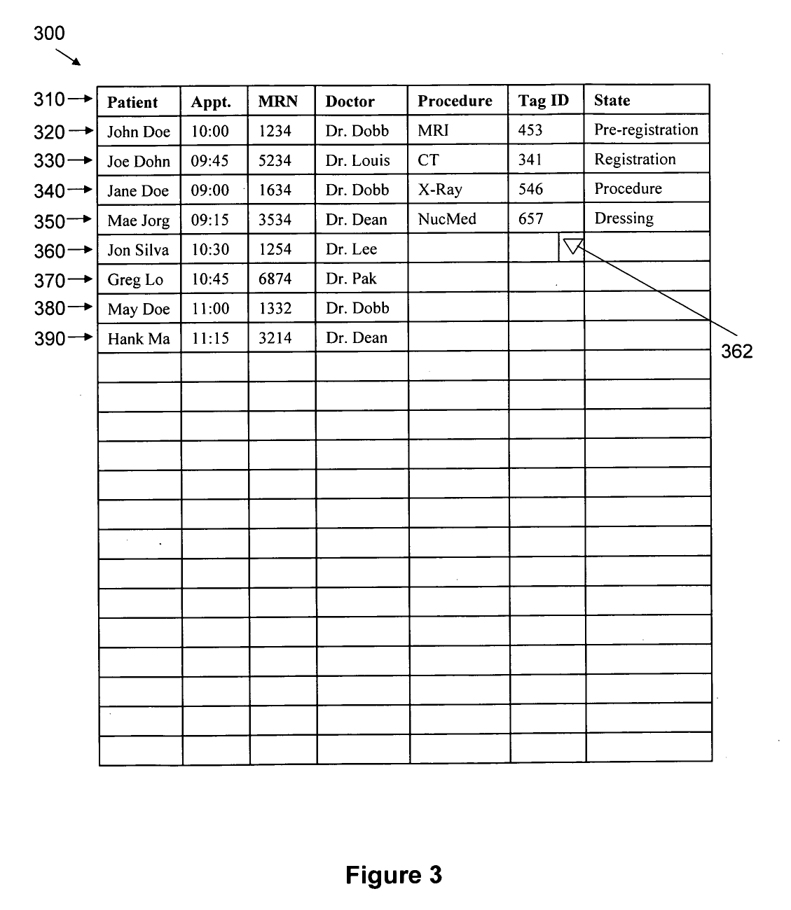

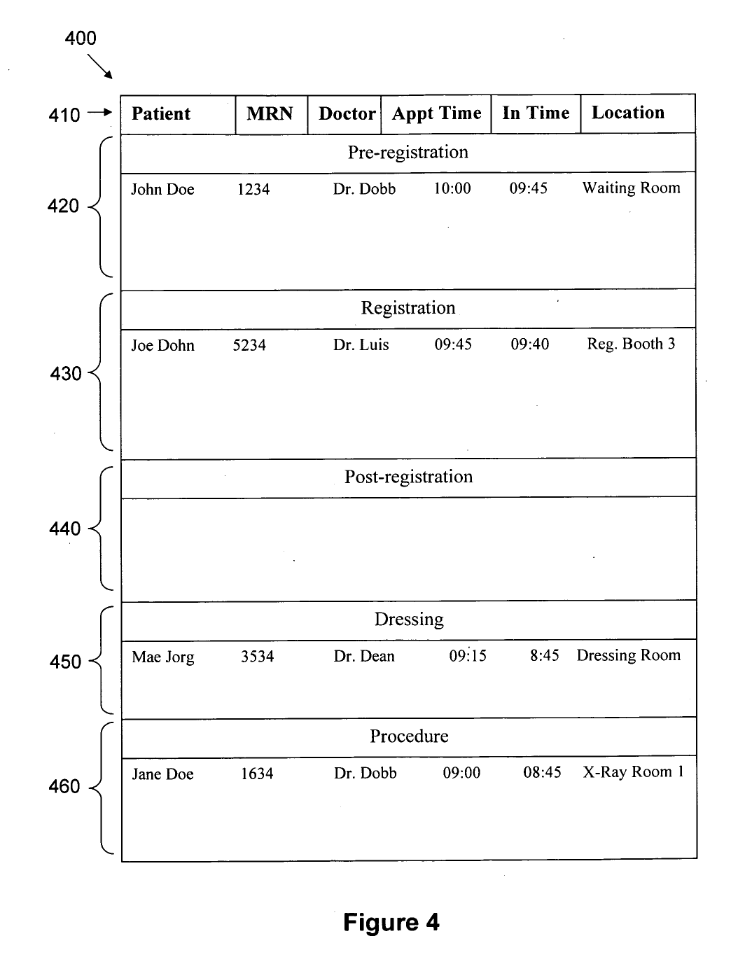

FIG. 2 shows a sample user interface that displays a dashboard with a patient filter selection 300 and a state filter selection 400. In FIG. 3, a closer view of patient filter selection 300 has a top header bar 310 and patient views 320,330, 340, 350,360,370, 380, and 390. The information in the patient views could be entered in manually by a user, for example a hospital receptionist, who intakes patients and enters patient information 140 accordingly. Preferably, the information in the patient views is automatically filled in, and the receptionist merely needs to assign a patient tag identification number to the patient using the drop-down menu 362, and give the patient tag to the patient, and the rest of the information becomes populated by the system. The system will propose a patient flow pattern (not shown) for the patient and will assign the patient to an appropriate state, depending on hospital resources and estimated wait time. From that point forward, a party who wishes to know the state of that patient could look at patient filter selection 300 to find what state that patient is in.

State filter selection 400 has a top header bar 410 and state designators 420, 430, 440, 450, and 460. This presents an alternate view of the state of each patient, by listing each state, and the patients who are in that state. At a glance, a user could see what resources are taken and which resources are available. For instance, in state designator 420 shows that one patient is currently using Registration Booth 3. If there are four registration booths at the medical facility, the user would immediately know that there are three registration booths available. This view could span one or more medical facilities for emergency patients in need of an operating room in a hospital that is particularly busy.

Many different kinds of user interface dashboards could be utilized to display information in real time, or display reports with a reporting engine that processes reports using information in the patient flow engine's database. Such reports could be incredibly useful to optimize use of the medical facility. For example, reports could be created to show when the peak times are for certain states, certain hospital assets, certain medical facilities, or certain doctors. Reports could be created to show how many patients were served in a given hour, day, week, month, or year. Reports could be created for each patient, or for a group of patients undergoing the same procedure so that analytics could be created for estimating time and cost to the medical facility. Reports could be created for certain procedures among different hospitals to analyze which hospitals are the most efficient. Reports could be created to analyze the amount of time patients typically wait, so that a medical facility could allocate personnel accordingly. Other reports could be created without departing from the scope of the previous invention.

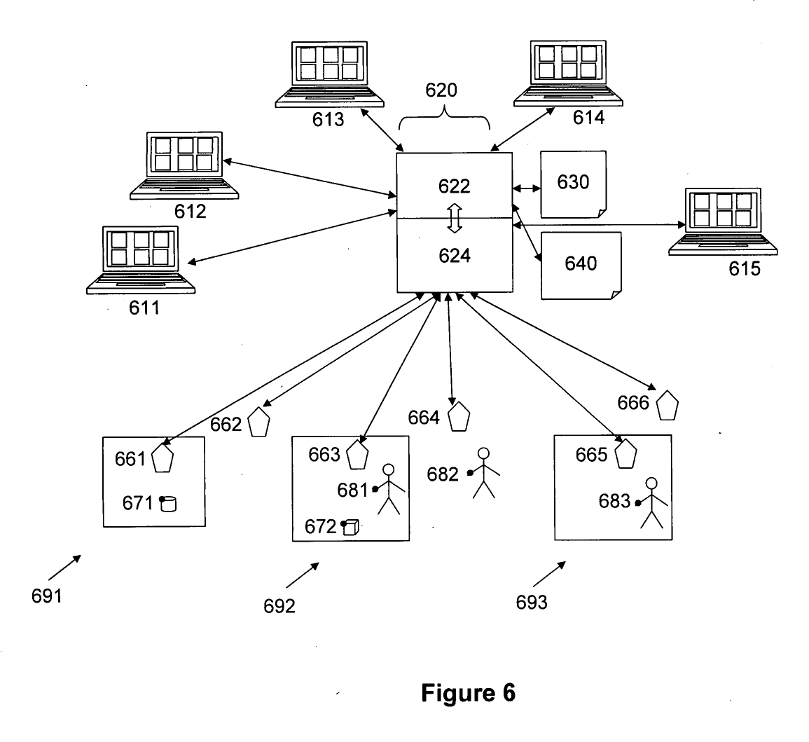

FIG. 5 shows a sample patient flow pattern 500, with prerequisite states 570 and non-prerequisite states 580. Prerequisite states 570 are states that need to be accomplished before the patient can enter another state, while non-prerequisite states could be accomplished at any time. A patient who is being treated with the patient flow pattern 500 could start in state 510, 562, 564, or 566. The medical staff or the patient flow engine could assign the patient arbitrarily, but preferably assigns the patient to a state that is the most available and/or is the closest to the patient's current location. As the patient moves through the patient flow pattern, the states close off when the patient accomplishes that state.

States 532, 534, and 536 are prerequisite states that must be accomplished before the patient can be assigned to state 540, but could be performed in any order. The patient flow engine could, again, assign the patient to a state that has the most free resources, so as to minimize wait time and maximize efficiency. As stated above, the patient flow engine could automatically move a patient from one state to another when that patient enters a trigger location. However, the patient flow engine could also change a patient's state when the patient remains in a location beyond a minimum threshold period of time, or when a medial staff sends a trigger signal to the patient flow engine. Preferably, the medical staff tags have trigger buttons or other kinds of user interfaces to allow the medical staff to send trigger signals to the management computer.

Typically, when a patient is assigned to a new state, commands are sent from the patient flow engine to authorized personnel. Typically such commands are part of a treatment process for the patient. For example, after a patient is assigned to a preop state, the system could send a command to the nearest nurse to escort the patient to a dressing room to prepare for an operation. After a patient is assigned to a discharge state, the patient tag could instruct the patient through a speaker or a map display how to exit the building and return the tag. After a patient is assigned to an operate state, the system could send a command to a doctor to commence the operation. Other kinds of commands could be sent without departing from the scope of the invention.

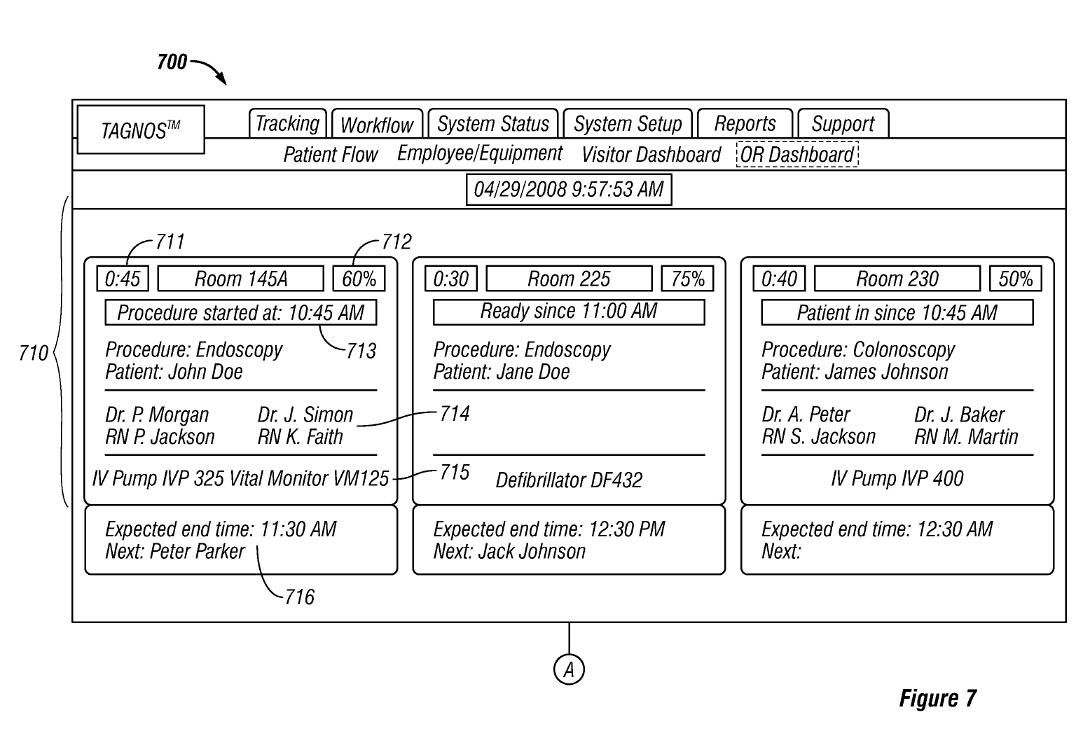

FIG. 6 shows a patient flow management system that treats the rooms themselves as a hospital asset. The patient flow management system has a management computer 620 functionally connected to a plurality of user interfaces 611, 612, 613, 614, 615, and a plurality of wireless detectors 661, 662, 663, 664, 665, 666. The patient flow management system keeps track of the use of operating rooms 691, 692, and 693 as recourses to be used as part of the patient flow pattern. Since rooms are static, they do not need to be tagged, but should have at least one wireless detector that monitors the room for tags that are entering and exiting designated areas. This is ideal for use in operating rooms, since operating room procedures are far more critical and costly, having a patient flow pattern dedicated towards allocating appropriate resources to the operating room is quite essential. However this technique could be applied to any number of different medical rooms that require orchestration.

The medical staff that needs to be orchestrated could encompass surgeons, nurses, anesthesiologists, housekeeping, and other support staff. These resources are not necessarily needed all at the same time, nor do they need to be present in the operating room throughout the duration of the procedure. However, for the procedure to begin and end on schedule, and be performed as planned, it is extremely important that the right resources are available at the right time, and the required events take place at the right time. The patient flow management system in FIG. 6 solves this problem by proposing a patient flow pattern for all of the assets in an operating room that accounts for all the dependencies and appropriate sequences of events, and automatically updating the state of the patient as trigger events occur. As above, trigger events could be based upon tags coinciding with trigger locations, tags coinciding with trigger locations for a minimum amount of time, trigger signals being sent from a tag, or a user inputting trigger signals from a user interface.

While orchestrating an operating room or other intensive medical procedure is incredibly complex, a patient flow pattern could still be used to orchestrate all of the medical staff, assets, and the patient him or herself. Additional tags may need to be used, to be clipped to different parts of the patient to detect the orientation and position of the patient, and for each individual equipment. Tagging equipment is especially important to prevent any equipment from accidentally being left in the patient. Alerts could also be set to go off when debilitating events occur, for example when the patient is has been under anesthesia for over five hours and has not yet been closed up. The alerts could optionally be forward to email addresses and pagers to alert outside personnel or management in extreme situations. By closely monitoring the procedure, anxious family members waiting outside the operating room could view a display screen and estimate when the procedure might end.

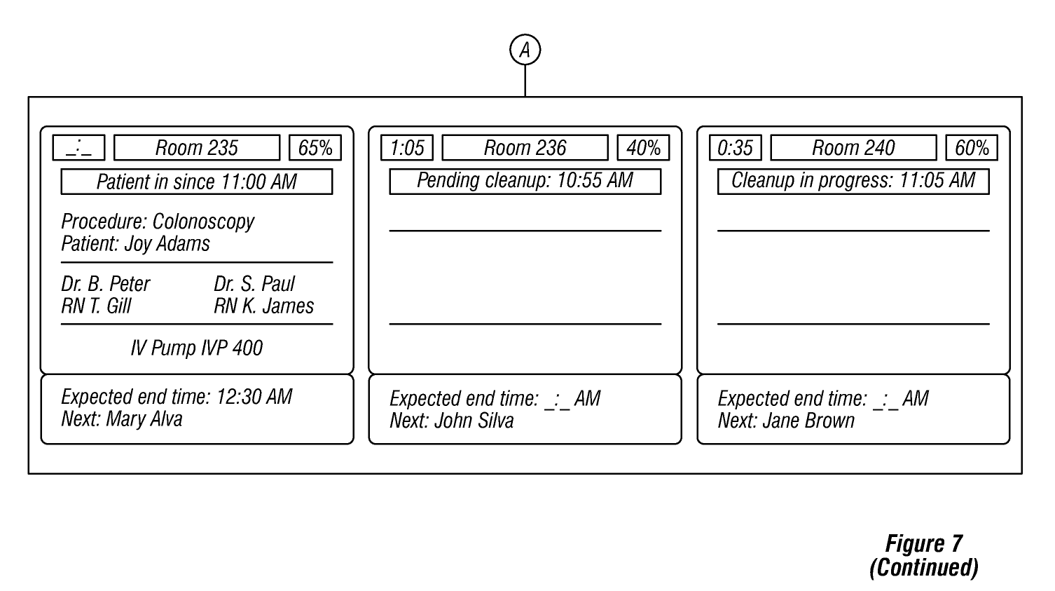

FIG. 7 shows an exemplary dashboard 700 that could display the statistics of the patient flow patterns being followed by the medical facility. Analyzing a report of one operating room 710, the estimated cleanup time 711, percent utilization of that room for the day 712, procedure start time 713, doctors currently in the operating room 714, equipment in use 715, and expected end time 716 could all be updated automatically without need for any input by the user. This autonomous, automatic updating of operating room information is sometimes crucial to a family member waiting outside, or a hospital administrator trying to schedule an emergency operation. These metrics could be stored in a database and mined in reports to help optimize the use of the operating rooms during peak seasons or times of the day.

Effective management and orchestration of multiple patients, medical staff, and medical assets is crucial to providing effective treatment options to patients. The exemplary embodiments above could be easily used in various departments in hospitals, for example in outpatient and inpatient surgery, radiology, emergency room, and diagnostic testing departments. Simply by providing this information to patients as they are being treated, stress and anxiety felt by patients who don't know how long their visit will last could be decreased. Patient throughput could also be increased by dynamically allocating resources towards where they are needed most and running reports to plan for expected recurring contingencies ahead of time. What cannot be measured cannot be managed, and effective patient flow management requires suitable tools to monitor, measure, analyze and report on the progress of patients as they move through the various stages such as registration, pre-procedure preparation, the actual procedure, and discharge. Once such metrics are available, they can be analyzed to identify bottlenecks along the flow, and to streamline the flow.

It should be apparent to those skilled in the art that many more modifications besides those already described are possible without departing from the inventive concepts herein. The inventive subject matter of providing a system and method for managing patients, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for managing patients, comprising:
assigning a first patient flow pattern to a first patient, wherein the first patient flow pattern comprises a first state and a second state;
assigning the first patient to the first state;
tracking a location of a first patient tag associated with the first patient;
automatically assigning the first patient to the second state as a function of the location of the first patient tag coinciding with a trigger location; and
treating the first patient in accordance with the first patient being in the second state.

2. The method of claim 1, further comprising:
receiving an information about the first patient; and
proposing the first patient flow pattern based upon the information about the first patient.

3. The method of claim 1, further comprising providing a user interface that allows a user to select the first patient flow pattern from a plurality of optional flow patterns.

4. The method of claim 1, further comprising providing a user interface through which a user can compose the first patient flow pattern.

5. The method of claim 1, further comprising sending a command to bring the first patient to a second state location after assigning the first patient to the second state.

6. The method of claim 1, further comprising:
tracking a location of an asset tag assigned to an asset; and
sending a command to bring the asset to a target asset location.

7. The method of claim 6, wherein the target asset location coincides with the location of the first patient tag.

8. The method of claim 1, further comprising assigning the first patient to a third state when the location of the first patient tag coincides with a second trigger location for a length of time.

9. The method of claim 1. further comprising receiving a trigger signal from a medical staff tag, and then assigning the first patient to a third state.

10. The method of claim 1, further comprising storing first patient tag information in a database, wherein the first patient tag information is selected from the group comprising the location of the first patient, a length of time the first patient coincides with the trigger location, a length of time the first patient is assigned to at least one of the first state and the second state, and a time when the first patient is assigned to at least one of the first and the second states.

11. The method of claim 10, further comprising creating a report based upon the first patient tag information.

12. The method of claim 1, further comprising:
proposing a second patient flow pattern to a second patient, wherein the second patient flow pattern comprises a third state and a fourth state;
assigning the second patient to the third state;
tracking a location of a second patient tag; and
assigning the second patient to the fourth state when the second patient tag enters a second trigger location.

13. The method of claim 12, further comprising using a display screen to display the location of the first patient tag and the location of the second patient tag.

14. The method of claim 12, further comprising using a display screen to display the second state with an identifier for the first patient and the fourth state with an identifier for the second patient.

15. A system for managing hospital patient flow, comprising:
a management computer configured to track a patient's progress through a patient flow pattern;
a patient tag that automatically sends a patient tag location to the management computer; and
a patient flow engine functionally connected to the management computer that changes a state of the patient's progress as a function of the patient tag location coinciding with a trigger location.

16. The system of claim 15, further comprising a wireless detector functionally connected to the management computer, wherein the patient tag automatically sends the patient tag location to the management computer through the wireless detector.

17. The system of claim 15, further comprising a display functionally connected to the management computer that displays a visual representation of the patient's progress through the patient flow.

18. The system of claim 15, further comprising a database that stores information about the patient's progress.

19. The system of claim 18, further comprising a reporting engine that creates reports based upon information within the database.

20. The system of claim 15, further comprising a staff tag that automatically sends a staff tag location to the management computer, wherein the patient flow engine changes the state of the patient's progress as a function of the staff tag location.
